(19) United States
(12) Patent Application Publication
(10) Pub. No.: US 2015/0014148 A1
(43) Pub. Date: Jan. 15, 2015

(54) Process for Energy Recovery in Manufacturing Cellulose Esters

(71) Applicant: Celanese Acetate LLC, Irving, TX (US)

(72) Inventor: Denis G. Fallon, Blacksburg, VA (US)

(21) Appl. No.: 13/939,239

(22) Filed: Jul. 11, 2013

(51) Int. Cl. B01D 3/00; B01D 11/04; B01D 3/36

(52) U.S. Cl. CPC B01D 3/007; B01D 3/36; B01D 11/04
USPC 203/14; 210/634

(57) ABSTRACT

Integration of an acid recovery system in the manufacturing of cellulose esters may include heat recovery from a carboxylic acid recovery distillation column by solvent extracting a weak acid stream to form a first overhead stream and a first bottoms stream; distilling the first overhead stream in a distillation column to form a second overhead stream and a second bottoms stream; sending at least a portion of the second overhead stream to a heat exchanger via a process inlet; sending a boiler feed water make up stream to the heat exchanger via a water inlet; and cooling the at least a portion of the second overhead stream in the heat exchanger, such that the at least a portion of second overhead stream exits the heat exchanger via a process outlet and the boiler feed water make up stream exits the heat exchanger via a water outlet.

### BACKGROUND

The present invention relates to integration of an acid recovery system in the manufacturing of cellulose esters with utility operations associated with the manufacturing process.

Acetic acid is a widely used aliphatic carbonic acid. Apart from its use as a reaction partner, e.g., during the production of cellulose esters, it is frequently also employed as a solvent, for instance, during the production of cellulose esters such as cellulose diacetate and cellulose triacetate. Aqueous acetic acid is obtained as a rule during the foregoing processes. In most cases, its recovery is of great economic significance. In the manufacture of cellulose esters, the recovery of the organic acid is particularly important. For example, in the manufacture of cellulose acetate, approximately 4 to 5.5 kilograms (kg) of acetic acid are used per 1 kg of cellulose acetate produced. About 0.5 kg of acetic acid is consumed in the production of 1 kg of cellulose acetate and the remaining 3.5 to 5 kg is discharged from the process. This discharged acetic acid is recovered and recycled into the cellulose acetate manufacturing process.

The discharged acid is recovered from an aqueous weak acid, created during cellulose ester precipitation. It may contain 23-35% organic acid, such as a carboxylic acid like acetic acid. Typically, the weak acid is first filtered to remove/recycle suspended cellulose acetate. Then the weak acid can be extracted using a solvent, wherein most of the water is separated as raffinate. The extract containing the organic acid, solvent, and dissolved water is separated using distillation, whereby the acid is separated out the base. Generally, in many chemical processes such as acetic acid production, distillation columns consume a significant amount of energy. The distillation columns may each independently receive the energy necessary to drive the separation within the column. The process of recovering the organic acid uses a substantial amount of energy in order to separate the organic acid from water and unwanted contaminates.

Accordingly, in view of the above considerations, there is a need to reduce the amount of energy needed to run the process or to somehow capture and reuse the energy that is put into the system. Any solution to the need must not negatively affect the acid recovery process itself or an associated units in the production facility.

### SUMMARY OF THE INVENTION

The present invention relates to integration of an acid recovery system in the manufacturing of cellulose esters with utility operations associated with the manufacturing process.

One embodiment of the present invention includes a process for the recovery of the heat from a carboxylic acid recovery distillation column, where the process includes the steps of: providing a weak acid stream generated from manufacturing a cellulose ester, manufacturing a carboxylic anhydride, or a combination thereof; solvent extracting the weak acid stream and thereby forming a first overhead stream and a first bottoms stream, wherein the first overhead stream comprises an organic acid, a solvent, and water; distilling the first overhead stream in a distillation column having a second overhead stream and a second bottoms stream, wherein the second overhead stream is vaporous and comprises about 90% or more of the solvent and water, and wherein the second bottoms stream comprises about 90% or more of the carboxylic acid; providing a first heat exchanger comprising a first process inlet, a first process outlet, a first water inlet, and a first water outlet; sending at least a portion of the second overhead stream to the first heat exchanger via the first process inlet and sending a boiler feed water make up stream to the first heat exchanger via the first water inlet; cooling the at least a portion of the second overhead stream in the first heat exchanger, such that the at least a portion of second overhead stream exits the first heat exchanger via the first process outlet and the boiler feed water make up stream exits the first heat exchanger via the first water outlet; wherein the first process outlet is at a lower temperature than the first process inlet; and, wherein the first water outlet is at a higher temperature than the first water inlet.

Another embodiment of the present invention includes a process for the recovery of the heat from a carboxylic acid recovery distillation column, where the process includes the steps of: providing a weak acid stream generated from the manufacture of a cellulose ester, the manufacture of a carboxylic anhydride, or a combination thereof, wherein the weak acid stream comprises a carboxylic acid and water; distilling the weak acid in a distillation column having an overhead stream and a bottoms stream, wherein the overhead stream is vaporous and comprises less than about 10% of the carboxylic acid, and wherein the bottoms stream comprises about 90% or more of the carboxylic acid; providing a first heat exchanger comprising a first process inlet, a first process outlet, a first water inlet, and a first water outlet; sending at least a portion of the overhead stream to the first heat exchanger via the first process inlet and sending a boiler feed water make up stream to the first heat exchanger via the first water inlet; cooling the at least a portion of the overhead stream in the first heat exchanger, such that the at least a portion of overhead stream exits the first heat exchanger via the first process outlet and the boiler feed water make up stream exits the first heat exchanger via the first water outlet; wherein the first process outlet is at a lower temperature than the first process inlet; and, wherein the first water outlet is at a higher temperature than the first water inlet.

The features and advantages of the present invention will be readily apparent to those skilled in the art upon a reading of the description of the preferred embodiments that follows.

### BRIEF DESCRIPTION OF THE DRAWINGS

The following figures are included to illustrate certain aspects of the present invention, and should not be viewed as exclusive embodiments. The subject matter disclosed is capable of considerable modifications, alterations, combinations, and equivalents in form and function, as will occur to those skilled in the art and having the benefit of this disclosure.

FIG. 1 illustrates an exemplary scheme according to one embodiment of the present invention.

FIG. 2 illustrates an exemplary scheme according to another embodiment of the present invention.

### DETAILED DESCRIPTION

In response to the need to recapture and reuse energy that is put into a carboxylic recovery system, such as acetic acid, propionic acid (also known as propanoic acid) or butyric acid, the present invention provides new and improved processes to advantageously increase the overall efficiency of the carboxylic acid recovery process using the energy contained in a distillation overhead to preheat utility streams such as boiler feed water. This invention integrates the energy needs of the acid recovery system in the manufacturing of cellulose esters with utility operations associated with the manufacturing process. In a cellulose ester manufacturing process the organic acid distillation can be the single largest source of higher temperature energy. Thus, the relatively large amount of latent heat available from the organic acid distillation top vapor can made available as a heat source for the boiler feed water makeup, which is typically a large flow stream and suitable heat sink. The heat available tends to be stable in both rate (mass available) and temperature; providing uniform for the utility boiler make-up water.

In other words, some embodiments of the present invention involve transferring heat, preferably excess heat, from the carboxylic acid recovery distillation column overhead to preheat boiler feed water. In conventional systems, the hot overhead stream would be cooled using cooling water and the excess heat would not be advantageously recovered. This recovery process will add to the efficiency of the overall carboxylic acid recovery unit and the supporting utilities unit; thus decreasing the costs of fuel and energy consumption.

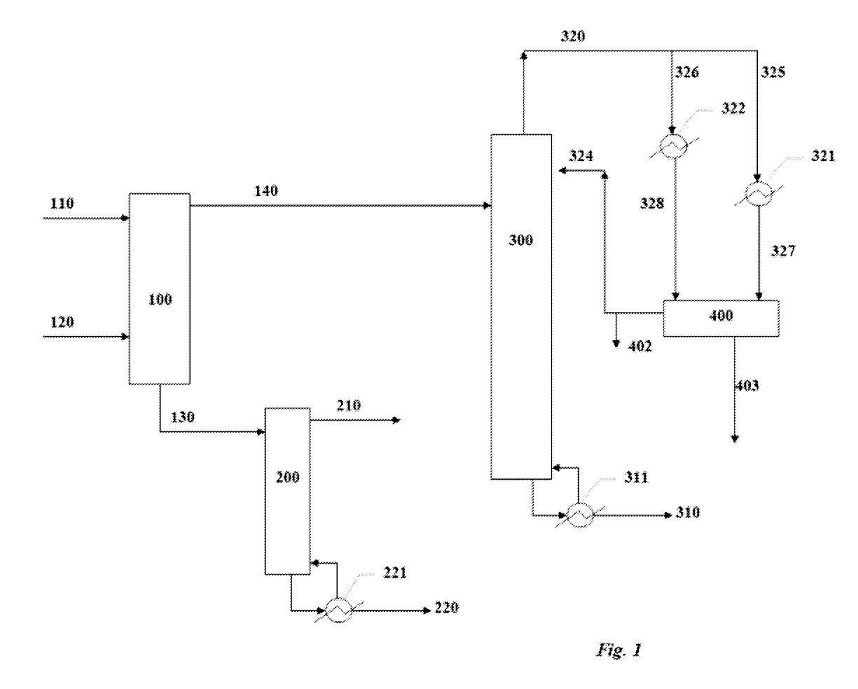

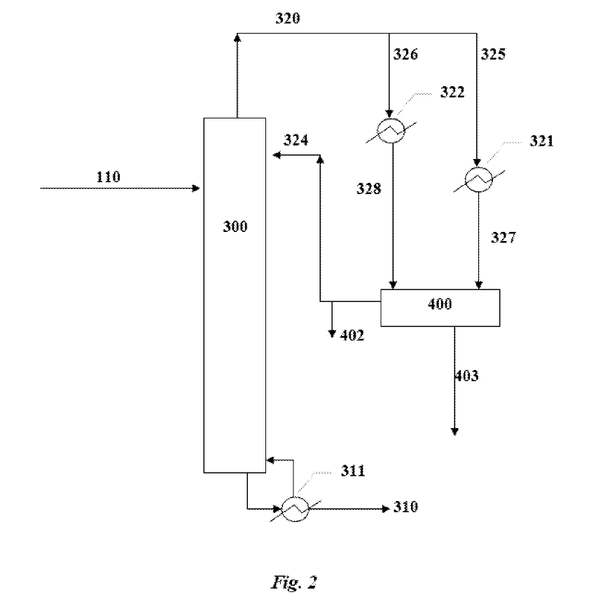

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, that will vary from one implementation to another, and would be a routine undertaking for those of ordinary skill in the art having the benefit of this disclosure. The reference numerals common to both FIG. 1 and FIG. 2 refer to identical features.

FIG. 1 shows an exemplary carboxylic acid recovery unit. The principal unit operation in the recovery of the carboxylic acid, which is in the form of an aqueous weak acid stream 110 comprising approximately between 20-65% by weight of carboxylic acid. Where FIG. 1 represents acid recovery associated with an acetic acid recovery system, weak acid stream 110 comprises approximately between 23-35% by weight of acetic acid, and may contain trace salts from the ester catalyst and/or trace suspended and dissolved cellulose esters. Where FIG. 1 represents acid recovery associated with an acetic acid recovery system, weak acid stream 110 comprises approximately between 23-60% by weight of acetic acid, little to no cellulose esters, and may contain trace catalyst salts. The liquid-liquid extractor 100 receives a top feed comprising weak acid stream 110 and a lower solvent feed 120. The extractor may be a baffled, trayed, or packed tower. A number of extraction solvents are available for use in the liquid-liquid extractor 100. The extraction solvent is generally a low boiling extraction agent such as organic esters (e.g., methyl acetate, ethyl acetate, isopropyl acetate, propyl acetate), ketones, alkanes, ethers (di-isopropyl ether, diethyl ether), benzene, and combinations thereof that have a boiling point less than the organic acid. Raffinate stream 130 comprises primarily water (generally about 90% or more) as well as about 2-10% solvent and may further comprise small amounts of alcohol, carboxylic acid, catalyst salts, and/or cellulose esters. Raffinate stream 130 exits near the bottom of liquid-liquid extractor 100 and is sent to a wastewater distillation stripper 200 to recover dissolved solvents in the distillate. The wastewater distillation stripper 200 may have either a reboiler or live steam injection at the bottom of the stripper that adds heat in order to drive solvents overhead, this is shown on FIG. 1 as element 221. This distillate would contain solvents, along with some water, which may be in the form of an azeotrope. Bottoms line 220 comprises wastewater, generally containing about 99% or more of water and may further contain small amounts of solvents, alcohols, salts, and/or cellulose esters. As bottoms line 220 has nearly all the solvents removed, it is suitable for downstream wastewater treatment. The overhead stream is removed via overhead line 210.

The overhead stream 140 is the organic extract phase comprising mostly solvent, about 8-19% carboxylic acid, and may contain residual water exits near the top of liquid-liquid extractor 100 and is sent to a carboxylic acid recovery column 300. It may be fed to this column as either a liquid stream, a vapor stream, or combination thereof. Recovery column 300 is a trayed or packed distillation column that includes reboiler 311 to add heat at the bottom of the column in order to separate a bottoms stream 310, which comprises about 99% carboxylic acid and may further comprise trace quantities of water, solvent, and/or cellulose esters. Where the terms “bottoms stream” or “overhead stream” are used one of skill in the art will recognize that the draw-off need not be the absolute top or bottom draw-offs, respectively, but may refer to a suitable side stream draw. The 99% carboxylic acid product may alternatively exit column 300 as a side draw off stream in the lower stage sections. This would create a more concentrated solids stream exiting the column bottoms for further processing. The overhead stream 320, comprising over 90% solvent, water, and trace carboxylic acid is an azeotropic mixture. That is, the water is azeotroped using the solvent at a boiling temperature less than that of either water or solvents.

Overhead stream 320 exits recovery column 300 as a hot vapor stream and is then condensed, the stream may optionally be subcooled. It is desirable to cool and condense overhead stream 320 before it is sent for further processing. While this could be done using plant cooling water, the process of the present invention instead uses heat exchanger 321, through which at least a portion of overhead stream 320 is cooled using boiler feed water make up. Thus, overhead stream 320 is condensed for further processing while simultaneously the boiler feed water make up experiences a desirable increase in temperature. Depending on the volume of boiler feed water make up available, all or a portion of overhead stream 320 may be processed through the boiler feed water heat exchanger 321.

In some instances as illustrated in FIG. 1, overhead stream 320 can be split into stream 325 that is sent to the boiler feed water heat exchanger 321 and stream 326 that is sent to a cooling water heat exchanger 322. One of skill in the art will recognize that where there is sufficient boiler feed water make up to adequately cool overhead stream 320, then stream 326 and cooling water heat exchanger 322 may not be necessary. Moreover, while streams 325 and 326 are shown in FIG. 1 as parallel, one of skill in the art will recognize that they could be operated such that the stream goes first to boiler feed water heat exchanger 321 and then to cooling water heat exchanger 322 in series. An advantage here is that a higher process temperature may be available as the vapor has not condensed to its dew point or subcooled.

In some instances, a hybrid of the foregoing embodiments may be applicable where at least one cooling water heat exchanger 322 is in series with using boiler feed water heat exchanger 321 and at least one cooling water heat exchanger 322 is in parallel with using boiler feed water heat exchanger 321.

Preferably 100% of overhead stream 320 is cooled using boiler feed water heat exchanger 321. However, the practical upper limit will depend on the operation of the particular unit at a particular site, and the number and sizes of available distillation towers. Of course, placement of a cooling water heat exchanger 322 is generally necessary to ensure adequate cooling in cases, for example, where boiler feed water make up flow can be variable. Having some fraction of cooling done by the more predictable cooling water flow may ensure better control of column cooling. In some instances, from about 5% to about 95% of overhead stream 320 can be cooled using boiler feed water heat exchanger 321.

In embodiments where an azeotroping agent has been used, the streams exiting the cooling water heat exchanger 322 (line 328) and leaving boiler feed water heat exchanger 321 (line 327) are sent to decanter 400. Within decanter 400, the cooled overhead fluid is allowed to separate into an organic upper phase and an aqueous lower phase. A fraction of the organic component is generally returned to column 300 as a recycle stream 324, while the remainder of the organic stream is pulled off as stream 402. Where the decanter 400 is used in an operation such as that shown in FIG. 1, it may be desirable to send most or all of the non-recycled organic stream (402) to combine with solvent feed 120 and be introduced to liquid-liquid extractor 100. The aqueous stream leaving the decanter 400 (stream 403) may be at least partially recycled into raffinate stream 130 and be introduced to wastewater distillation stripper 200. In some instances, all may be recycled.

In embodiments where no azeotroping agent was used, the overhead stream 320 is condensed and collected in a reflux tank. Condensed overhead that is not returned to the still as reflux is sent on for further processing or if low enough in acid content can be discharged directly to the wastewater treatment system. Generally, overhead stream 320 ranges in temperature from about 65° C. to about 110° C. Depending on the season and the location of the facility, boiler feed water make up may range from about 10° C. to about 90° C. The rise in temperature that may be experienced by the boiler feed water make up through heat exchanger 321 depends upon a number of factors, including: the temperature of overhead stream 320, the temperature of the boiler feed water make up, and the respective volumes of boiler feed water make up sent through heat exchanger 321 and the volume in stream 325 sent through heat exchanger 321, the exchanger design to maximize counter current heat transfer, and the purity of the boiler feed water makeup. In preferred embodiments, the boiler feed water make up may experience an increase in temperature of at least about 25° C. and up to about 100° C. The vapor overhead stream 320 is preferably completely condensed in heat exchanger 321 and/or heat exchanger 322 and experiences a decrease in temperature of at least about 10° C. and up to about 90° C.

In some embodiments, the solvent can be used in the same manner where no extractor is used. In this case, the weak acid can be fed directly to the distillation column and sufficient solvent added to azeotrope all water out the top. Still another variation can be direct distillation of the water from the acid using no solvent. However, this variation may be disadvantageous where carboxylic acid concentration is less than about 50-60% and requires more trays for separation. In the alternative embodiment shown in FIG. 2 with continued reference to FIG. 1, weak acid stream 110 is sent directly to carboxylic acid recovery column 300. In such embodiments, it may be desirable to include an azeotroping agent to aid in separation. While an azeotroping agent is not required, when used suitable agents include organic esters, ketones, ethers, alkanes, and aromatic compounds that boil lower than acetic acid. One of skill in the art will recognize that where an azeotroping agent is not used, a decanter (such as 400 in FIGS. 1 and 2) will not be needed to separate phases from the top of the carboxylic acid recovery column 300, and instead, the lines 327 and 328 can be sent to any suitable vessel.

Embodiments disclosed herein include:

A: a process for the recovery of the heat from a carboxylic acid recovery distillation column, where the process includes the steps of: providing a weak acid stream generated from manufacturing a cellulose ester, manufacturing a carboxylic anhydride, or a combination thereof; solvent extracting the weak acid stream and thereby forming a first overhead stream and a first bottoms stream, wherein the first overhead stream comprises an organic acid, a solvent, and water; distilling the first overhead stream in a distillation column having a second overhead stream and a second bottoms stream, wherein the second overhead stream is vaporous and comprises about 90% or more of the solvent and water, and wherein the second bottoms stream comprises about 90% or more of the carboxylic acid; providing a first heat exchanger comprising a first process inlet, a first process outlet, a first water inlet, and a first water outlet; sending at least a portion of the second overhead stream to the first heat exchanger via the first process inlet and sending a boiler feed water make up stream to the first heat exchanger via the first water inlet; cooling the at least a portion of the second overhead stream in the first heat exchanger, such that the at least a portion of second overhead stream exits the first heat exchanger via the first process outlet and the boiler feed water make up stream exits the first heat exchanger via the first water outlet; wherein the first process outlet is at a lower temperature than the first process inlet; and, wherein the first water outlet is at a higher temperature than the first water inlet; and

B: a process for the recovery of the heat from a carboxylic acid recovery distillation column, where the process includes the steps of: providing a weak acid stream generated from the manufacture of a cellulose ester, the manufacture of a carboxylic anhydride, or a combination thereof, wherein the weak acid stream comprises a carboxylic acid and water; distilling the weak acid in a distillation column having an overhead stream and a bottoms stream, wherein the overhead stream is vaporous and comprises less than about 10% of the carboxylic acid, and wherein the bottoms stream comprises about 90% or more of the carboxylic acid; providing a first heat exchanger comprising a first process inlet, a first process outlet, a first water inlet, and a first water outlet; sending at least a portion of the overhead stream to the first heat exchanger via the first process inlet and sending a boiler feed water make up stream to the first heat exchanger via the first water inlet; cooling the at least a portion of the overhead stream in the first heat exchanger, such that the at least a portion of overhead stream exits the first heat exchanger via the first process outlet and the boiler feed water make up stream exits the first heat exchanger via the first water outlet; wherein the first process outlet is at a lower temperature than the first process inlet; and, wherein the first water outlet is at a higher temperature than the first water inlet.

Each of Embodiments A and B may have one or more of the following additional elements in any combination: Element 1: the solvent comprising a material have a boiling point less than the acetic acid selected from the group consisting of: an organic ester, a ketone, an alkane, an ether, benzene, and combinations thereof; Element 2: the first process inlet having a temperature of between 65° C. and 110° C. and the first process outlet having a temperature of between 20° C. and 100° C.; Element 3: the first water inlet has a temperature of between 10° C. and 90° C. and the first water outlet has a temperature of between 20° C. and 100° C.; Element 4: the process further including providing a second heat exchanger in parallel with the first heat exchanger, the second heat exchanger comprising a second process inlet, a second process outlet, a second water inlet, and a second water outlet; sending a second portion of the second overhead stream to the second heat exchanger via a second process inlet and sending a cooling water stream to the second heat exchanger via a second water inlet; cooling the second portion of the second overhead stream in the second heat exchanger, such that the second portion of the second overhead stream exits the second heat exchanger via the second process outlet and the cooling water stream exits the second heat exchanger via the second water outlet; wherein the second process outlet is at a lower temperature than the second process inlet; and, wherein the second water outlet is at a higher temperature than the second water inlet; and Element 5: the process further including providing a second heat exchanger in series with the first heat exchanger, the second heat exchanger comprising a second process inlet, a second process outlet, a second water inlet, and a second water outlet; sending at least a portion of an effluent of the first heat exchanger from the first heat exchanger process outlet to the second heat exchanger via the second process inlet and sending a cooling water stream to the second heat exchanger via a second water inlet; cooling the at least a portion of the effluent in the second heat exchanger, such that the at least a portion of the effluent exits the second heat exchanger via the second process outlet and the cooling water stream exits the second heat exchanger via the second water outlet; wherein the second process outlet is at a lower temperature than the second process inlet; and, wherein the second water outlet is at a higher temperature than the second water inlet.

By way of non-limiting example, exemplary combinations applicable to Embodiments A and B include: Element 1 in combination with Element 2; Element 2 in combination with Element 3; Element 1 in combination with Element 3; Element 4 in combination with at least one of Elements 1-3; Element 5 in combination with at least one of Elements 1-3; Element 4 in combination with Element 5; and so on.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present invention. The invention illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces. If there is any conflict in the usages of a word or term in this specification and one or more patent or other documents that may be incorporated herein by reference, the definitions that are consistent with this specification should be adopted.

The invention claimed is:

1. A process for the recovery of the heat from a carboxylic acid recovery distillation column, comprising the steps of:
providing a weak acid stream generated from manufacturing a cellulose ester, manufacturing a carboxylic anhydride, or a combination thereof;
solvent extracting the weak acid stream and thereby forming a first overhead stream and a first bottoms stream, wherein the first overhead stream comprises an organic acid, a solvent, and water;
distilling the first overhead stream in a distillation column having a second overhead stream and a second bottoms stream, wherein the second overhead stream is vaporous and comprises about 90% or more of the solvent and water, and wherein the second bottoms stream comprises about 90% or more of the carboxylic acid;
providing a first heat exchanger comprising a first process inlet, a first process outlet, a first water inlet, and a first water outlet;
sending at least a portion of the second overhead stream to the first heat exchanger via the first process inlet and sending a boiler feed water make up stream to the first heat exchanger via the first water inlet;
cooling the at least a portion of the second overhead stream in the first heat exchanger, such that the at least a portion of second overhead stream exits the first heat exchanger via the first process outlet and the boiler feed water make up stream exits the first heat exchanger via the first water outlet;
wherein the first process outlet is at a lower temperature than the first process inlet; and,
wherein the first water outlet is at a higher temperature than the first water inlet.

2. The process of claim 1 wherein the solvent comprises a material have a boiling point less than the acetic acid selected from the group consisting of: an organic ester, a ketone, an alkane, an ether, benzene, and combinations thereof.

3. The process of claim 1 wherein the first process inlet has a temperature of between 65° C. and 110° C. and the first process outlet has a temperature of between 20° C. and 100° C.

4. The process of claim 1 wherein the first water inlet has a temperature of between 10° C. and 90° C. and the first water outlet has a temperature of between 20° C. and 100° C.

5. The process of claim 1 further comprising:
providing a second heat exchanger in parallel with the first heat exchanger, the second heat exchanger comprising a second process inlet, a second process outlet, a second water inlet, and a second water outlet;
sending a second portion of the second overhead stream to the second heat exchanger via a second process inlet and sending a cooling water stream to the second heat exchanger via a second water inlet;
cooling the second portion of the second overhead stream in the second heat exchanger, such that the second portion of the second overhead stream exits the second heat exchanger via the second process outlet and the cooling water stream exits the second heat exchanger via the second water outlet;
wherein the second process outlet is at a lower temperature than the second process inlet; and,
wherein the second water outlet is at a higher temperature than the second water inlet.

6. The process of claim 1 further comprising:
providing a second heat exchanger in series with the first heat exchanger, the second heat exchanger comprising a second process inlet, a second process outlet, a second water inlet, and a second water outlet;
sending at least a portion of an effluent of the first heat exchanger from the first heat exchanger process outlet to the second heat exchanger via the second process inlet and sending a cooling water stream to the second heat exchanger via a second water inlet;
cooling the at least a portion of the effluent in the second heat exchanger, such that the at least a portion of the effluent exits the second heat exchanger via the second process outlet and the cooling water stream exits the second heat exchanger via the second water outlet;
wherein the second process outlet is at a lower temperature than the second process inlet; and,
wherein the second water outlet is at a higher temperature than the second water inlet.

7. A process for the recovery of the heat from a carboxylic acid recovery distillation column, comprising the steps of:
providing a weak acid stream generated from the manufacture of a cellulose ester, the manufacture of a carboxylic anhydride, or a combination thereof, wherein the weak acid stream comprises a carboxylic acid and water;
distilling the weak acid in a distillation column having an overhead stream and a bottoms stream, wherein the overhead stream is vaporous and comprises less than about 10% of the carboxylic acid, and wherein the bottoms stream comprises about 90% or more of the carboxylic acid;
providing a first heat exchanger comprising a first process inlet, a first process outlet, a first water inlet, and a first water outlet;
sending at least a portion of the overhead stream to the first heat exchanger via the first process inlet and sending a boiler feed water make up stream to the first heat exchanger via the first water inlet;
cooling the at least a portion of the overhead stream in the first heat exchanger, such that the at least a portion of overhead stream exits the first heat exchanger via the first process outlet and the boiler feed water make up stream exits the first heat exchanger via the first water outlet;
wherein the first process outlet is at a lower temperature than the first process inlet; and,
wherein the first water outlet is at a higher temperature than the first water inlet.

8. The process of claim 7 further comprising introducing an azeotroping agent to the distillation column along with the weak acid stream.

9. The process of claim 7 further comprising:
providing a second heat exchanger in parallel with the first heat exchanger, the second heat exchanger comprising a second process inlet, a second process outlet, a second water inlet, and a second water outlet;
sending a second portion of the second overhead stream to the second heat exchanger via a second process inlet and sending a cooling water stream to the second heat exchanger via a second water inlet;
cooling the second portion of the second overhead stream in the second heat exchanger, such that the second portion of the second overhead stream exits the second heat exchanger via the second process outlet and the cooling water stream exits the second heat exchanger via the second water outlet;
wherein the second process outlet is at a lower temperature than the second process inlet; and,
wherein the second water outlet is at a higher temperature than the second water inlet.

10. The process of claim 7 further comprising:
providing a second heat exchanger in series with the first heat exchanger, the second heat exchanger comprising a second process inlet, a second process outlet, a second water inlet, and a second water outlet;
sending at least a portion of an effluent of the first heat exchanger from the first heat exchanger process outlet to the second heat exchanger via the second process inlet and sending a cooling water stream to the second heat exchanger via a second water inlet;
cooling the at least a portion of the effluent in the second heat exchanger, such that the at least a portion of the effluent exits the second heat exchanger via the second process outlet and the cooling water stream exits the second heat exchanger via the second water outlet;
wherein the second process outlet is at a lower temperature than the second process inlet; and
wherein the second water outlet is at a higher temperature than the second water inlet.
